(19) United States
(12) Patent Application Publication
(10) Pub. No.: US 2008/0120448 A1
(43) Pub. Date: May 22, 2008

(54) REMOTE MOUSE AND KEYBOARD USING BLUETOOTH

(75) Inventors: Yan Shi, Haerbin (CN); Kong-Kat Wong, Renton, WA (US); Difei Tang, Beijing (CN); Wei Hun Liew, Beijing (CN); Sun Hsuen Shaw, Beijing (CN)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/562,398

(22) Filed: Nov. 21, 2006

(51) Int. Cl. G06F 13/12

(52) U.S. Cl. 710/72

(57) ABSTRACT

A remote pointing device and keyboard system and method for remotely mimicking the pointing device and keyboard of a personal computing device (such as a laptop or desktop computer) using a handheld computing device (such as Pocket PC or smartphone). Remote control is achieved using Bluetooth wireless technology. A user inputs commands on a touch panel of the handheld device to remotely control the pointing device on the personal computing device. Similarly, the user input data on a keypad of the handheld device to remotely enter keystrokes to the personal computing device, thereby bypassing the keyboard. This allows the user to remotely access the pointing device and keyboard of the personal computing device through the touch panel and keypad of the handheld device.

### BACKGROUND

Frequently situations arise where it is desirable to be able to control a personal computing device (such as a desktop or laptop computer) from a handheld computing device. For example, when giving presentations a presenter often will uses slide or other material contained on and displayed by a personal computing device. In order to move the presentation along, the presenter needs to interact with the computer. This interaction includes switching slides, running other applications, and inputting commands using a pointing device (such as a mouse or touchpad) or data using a keyboard.

One problem with this arrangement is that the presenter's movements are constrained to the small area surrounding the computer. A remote control can be used to partially alleviate this problem, as the remote control can be used to advance the slides. The problem is not entirely resolved, however, because a remote control cannot be used to open, close, and otherwise control the other applications on the computer. Moreover, the remote control cannot be used to remotely input commands and data.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The remote pointing device and keyboard system and method includes simulating or mimicking the keyboard and pointing device behavior of a personal computing device by using the touch panel and keypad of a handheld computing device (such as a Pocket PC or smartphone). In other words, the touch panel and keypad of the mobile device are used as a remote mouse pad and keyboard of a PC. The remote pointing device and keyboard system and method causes the Pocket PC to act as a remote keyboard and mouse to be able to control the desktop or laptop computer. The touch pane of the Pocket PC acts as a remote mouse, such that if you double click on the screen of the Pocket PC an application will open. Remote control is established using a Bluetooth connection. Bluetooth wireless technology is used because it is in widespread used worldwide and Bluetooth technology is legal in many countries, even where other types of wireless technologies are illegal.

The remote pointing device and keyboard system and method is useful in situations such as giving presentations. Using the remote pointing device and keyboard system and method, the presenter can give the lecture freely and use his mobile device control the computer at anywhere within the range of the Bluetooth connection. For example, assume that a presenter is using a laptop or desktop computer that contains a Powerpoint presentation and the laptop or desktop computer is Bluetooth enabled. Moreover, the presenter has another Bluetooth-enable device that is a Pocket PC or smartphone. Using the remote pointing device and keyboard system and method, the presenter can remotely access the mouse and keyboard of the laptop or desktop computer using the touch panel and keypad of the Pocket PC or smartphone. In addition, the Pocket PC or smartphone can be used to control every behavior of the laptop or desktop, including opening, closing, and editing documents and applications.

In one embodiment, the remote pointing device and keyboard system and method includes a personal computing device (having a keyboard and pointing device) and a handheld computing device (having a touch panel or touch screen and a keypad). Both devices are Bluetooth-enabled devices. The personal computing device is running a first application, and the handheld computing device is running a second application.

Both the first and second applications are activated on their respective computing devices. A user then inputs commands into the handheld computing device using the touch panel, and inputs data into the handheld using the keypad. The user intends that the input commands and data are for the personal computing device. The handheld sends the commands and data to the personal computing device using the Bluetooth connection.

The personal computing device receives this message and translates it into the desired keyboard or pointing device behavior intended by the user. In some embodiments this involves the translation of coordinates in the touch panel domain to coordinates in the display device domain of the personal computing device. The translated commands and data then are sent to the operating system of the personal computing device, and the operating system executes the commands and processes the data. In this manner the user can remotely access the pointing device and keyboard of the personal computing device through the touch panel and keypad of the handheld device.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating an exemplary implementation of the remote pointing device and keyboard system disclosed herein.

FIG. 2 is a flow diagram illustrating the detailed operation of the method used by the remote pointing device and keyboard system shown in FIG. 1.

FIG. 3 is a flow diagram illustrating the operation of the application running on the personal computing device shown in FIG. 1.

FIG. 4 is a flow diagram illustrating the operation of the application running on the handheld computing device shown in FIG. 1.

FIG. 5 illustrates an example of a suitable computing system environment in which the remote pointing device and keyboard system and method shown in FIGS. 1-4 may be implemented.

### DETAILED DESCRIPTION

In the following description of the remote pointing device and keyboard system and method, reference is made to the accompanying drawings, which form a part thereof, and in which is shown by way of illustration a specific example whereby the remote pointing device and keyboard system and method may be practiced. It is to be understood that other embodiments may be utilized and structural changes may be made without departing from the scope of the claimed subject matter.

### I. System and Operational Overview

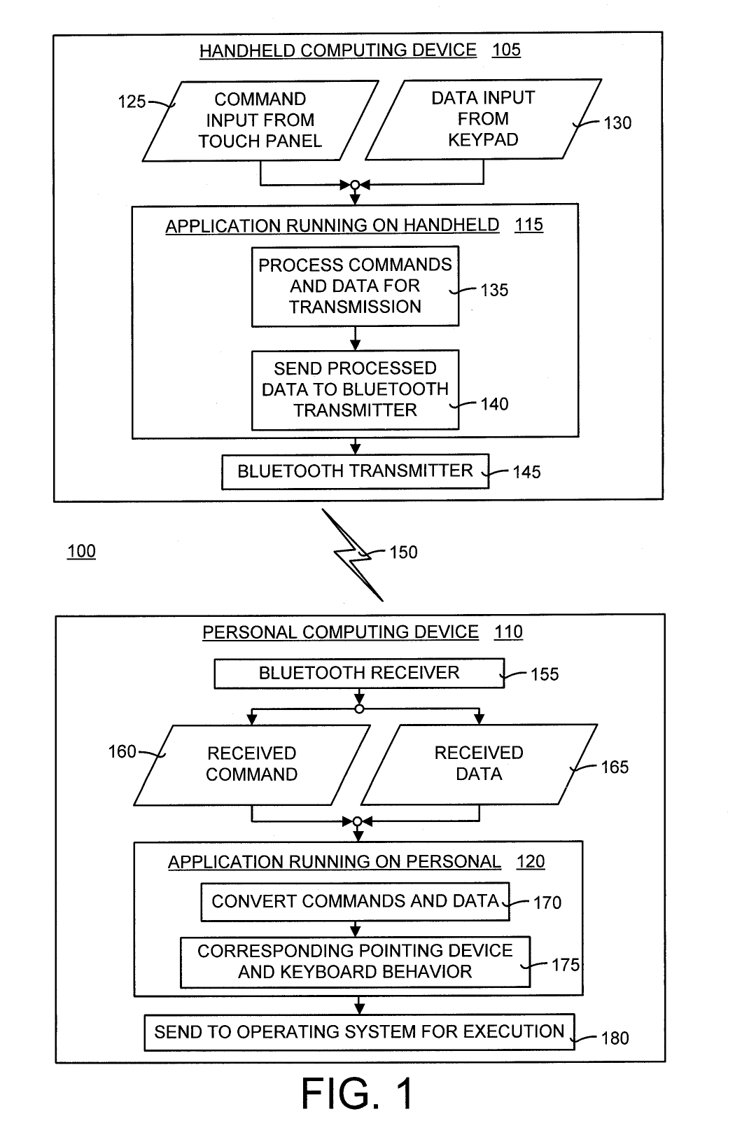

FIG. 1 is a block diagram illustrating an exemplary implementation of the remote pointing device and keyboard system 100 disclosed herein. It should be noted that FIG. 1 is merely one of several ways in which the remote pointing device and keyboard system 100 may be implemented and used. The remote pointing device and keyboard system 100 may be implemented on various types of processing systems, such as on a central processing unit (CPU) or multi-core processing systems.

Referring to FIG. 1, the remote pointing device and keyboard system 100 includes two computing devices: a handheld computing device 105 (such as a Pocket PC (PPC) or a smartphone) and a personal computing device 110 (such as a desktop or laptop computer). In some embodiments the handheld computing device 105 has some means of emulating a pointing device and a keyboard. For example, a touch panel (or touch screen) can emulate a pointing device by having a user with a stylus move over the touch panel. Similarly, a keypad on the handheld device 105 can be used to emulate a keyboard. In some cases, the keypad will be displayed on the touch panel and accessed by using the stylus to press the keys.

The handheld computing device 105 includes a second application running on the device 105. The personal computing device 110 is running a first application 120. Referring to the handheld computing device 105, a user (not shown) provides input to the device 105 by means of a command input from the touch panel (box 125). In addition, data input may come from the user through a keypad (box 130).

These commands 125 and data 130 are sent to the second application 115 to be processed for transmission (box 135). This process command and data information then is sent to a Bluetooth transmitter 140. Bluetooth uses radio frequencies to provide wireless data transfer between Bluetooth-enabled devices. Bluetooth is a fairly ubiquitous wireless data transfer technology, with an ever-increasing number of Bluetooth-enabled desktop computers, laptop computers, and handheld devices being sold. The processed data is send to the Bluetooth transmitter 145 and wirelessly transmitted 150 to the personal computing device 110.

A Bluetooth receiver 155 on the personal computing device 110 receives the incoming message. The message is parsed into received commands 160 and received data 165. In general, the received commands 160 are input obtained from the touch panel of the handheld computing device 105 relating to pointing device instructions, while the received data 165 is input obtained from the keypad of the handheld computing device 105 relating to keyboard instructions.

The first application running on the personal computing device 120 processes the received message to convert the commands and data into instructions relating to the pointing device and the keyboard (box 170). This processing yields corresponding pointing device behavior and keyboard behavior 175. These instructions then are sent to the operating system for execution (box 180).

### II. Operational Details

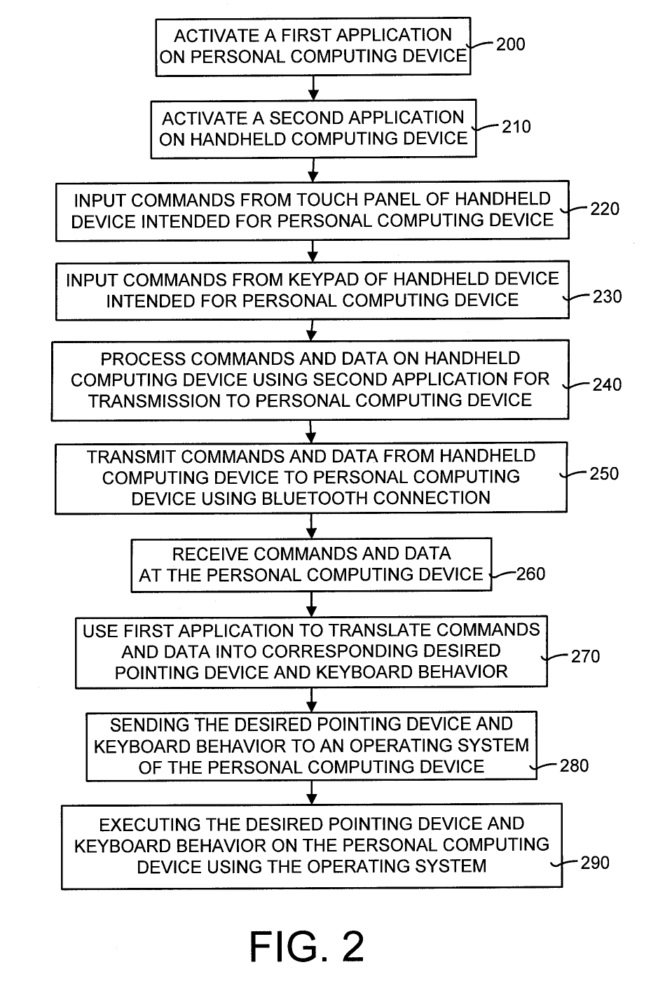

FIG. 2 is a flow diagram illustrating the detailed operation of the method used by the remote pointing device and keyboard system 100 shown in FIG. 1. The remote pointing device and keyboard method can be used to remotely mimic the behavior of a pointing device and keyboard on a desktop or laptop by using a Bluetooth-enabled handheld device. In particular, the remote pointing device and keyboard method begins by activating a first application on the personal computing device (box 200) and activating a second application on a handheld computing device (box 210).

A user send commands and data to the personal computing device 110 by using the handheld computing device 105. More specifically, the user inputs commands from the touch panel (box 220) and data from the keypad (box 230) of the handheld computing device 105. These commands and data are intended for the personal computing device 110. By activating the first 120 and second 115 applications, the user expresses his intent of remotely sending his command and data input of the handheld computing device 105 to the personal computing device 110.

The second application 115 processes the commands and data on the handheld computing device for transmission to the personal computing device (box 240). The handheld computing device 105 transmits the commands and data from the handheld computing device 105 to the personal computing device 110 using a Bluetooth connection (box 250).

The personal computing device 110 receives the transmitted commands and data (box 260). The first application 120 then is used to translate the commands and data into corresponding pointing device and keyboard behavior (box 270). This pointing device and keyboard behavior is that behavior that was desired by the user when he input the commands and data using the handheld computing device 105. The desired pointing device and keyboard behavior is sent to the operating system (box 280), and then executed by the operating system on the personal computing device (box 290).

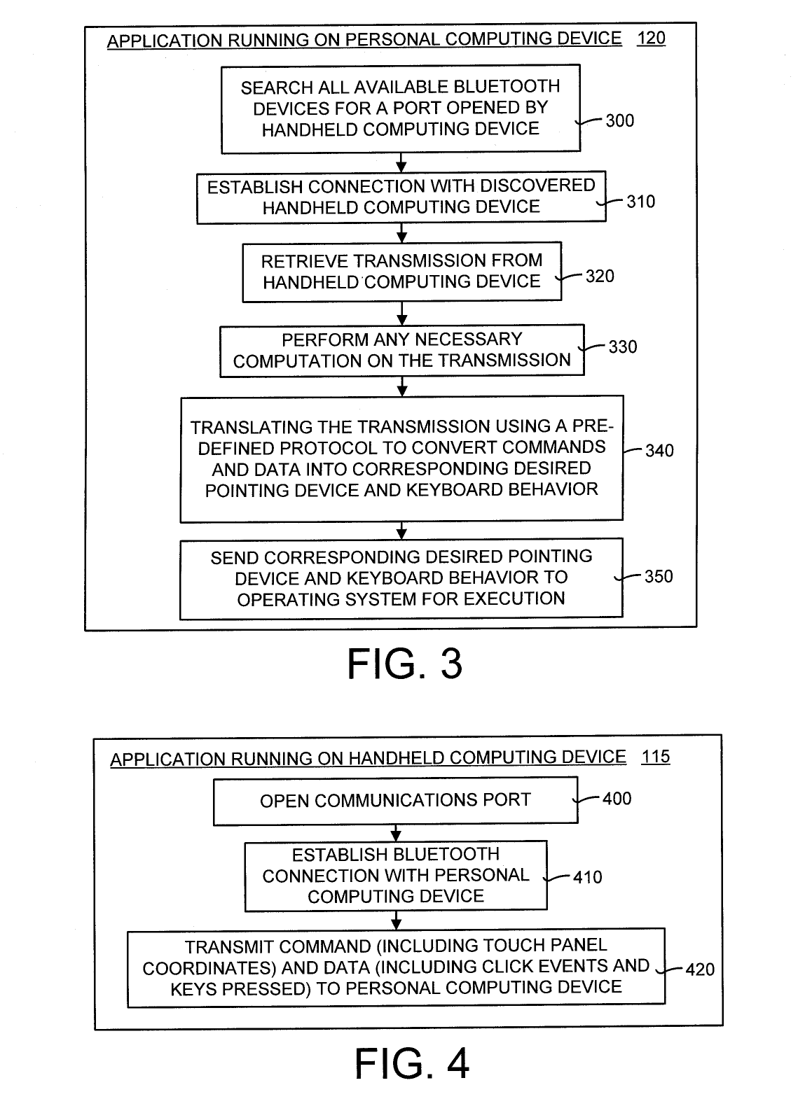

FIG. 3 is a flow diagram illustrating the operation of the application running on the personal computing device 120 shown in FIG. 1. This first application initially searches all available Bluetooth devices for a port opened by the handheld computing device (box 300). If the handheld computing device 105 is found by the first application 120 (as it should be if the port is opened successfully by the device 105), then a connection between the handheld computing device 105 and the personal computing device 110 is established (box 310). Once the connection is established, the first application 120 waits for a transmitted message from the handheld computing device 105, and then retrieves the message (box 320).

Any necessary computations are performed on the received transmission (box 330). Next, the transmission is translated using a pre-defined protocol to convert commands and data from the handheld computing device 105 into corresponding desired pointing device and keyboard behavior (box 340). In some embodiments, this pre-defined protocol includes converting touch panel x-y coordinates of the handheld computing device 105 into to display device x-y coordinates on the personal computing device 110. In addition, in some embodiments this pre-defined protocol includes converting clicking event information and key pressed information performed on the handheld computing device 105 into clicking event information and keyboard data on the personal computing device 110. Finally, the corresponding desired pointing device and keyboard behavior is send to the operating system of the personal computing device 110 for execution (box 350). In this way the user can control the behavior of the computer through the device.

FIG. 4 is a flow diagram illustrating the operation of the application running on the handheld computing device 115 shown in FIG. 1. The second application 115 opens a communication port on the handheld computing device (box 400). Next, a Bluetooth connection is established with the personal computing device (box 410). Finally, the second application 115 transmits commands and data to the personal computing device over the Bluetooth connection (box 420). In some embodiments, the commands include touch panel coordinates and the data includes click events and keys pressed.

### III. Exemplary Operating Environment

The remote pointing device and keyboard system and method is designed to operate in a computing environment. The following discussion is intended to provide a brief, general description of a suitable computing environment in which the remote pointing device and keyboard system and method may be implemented.

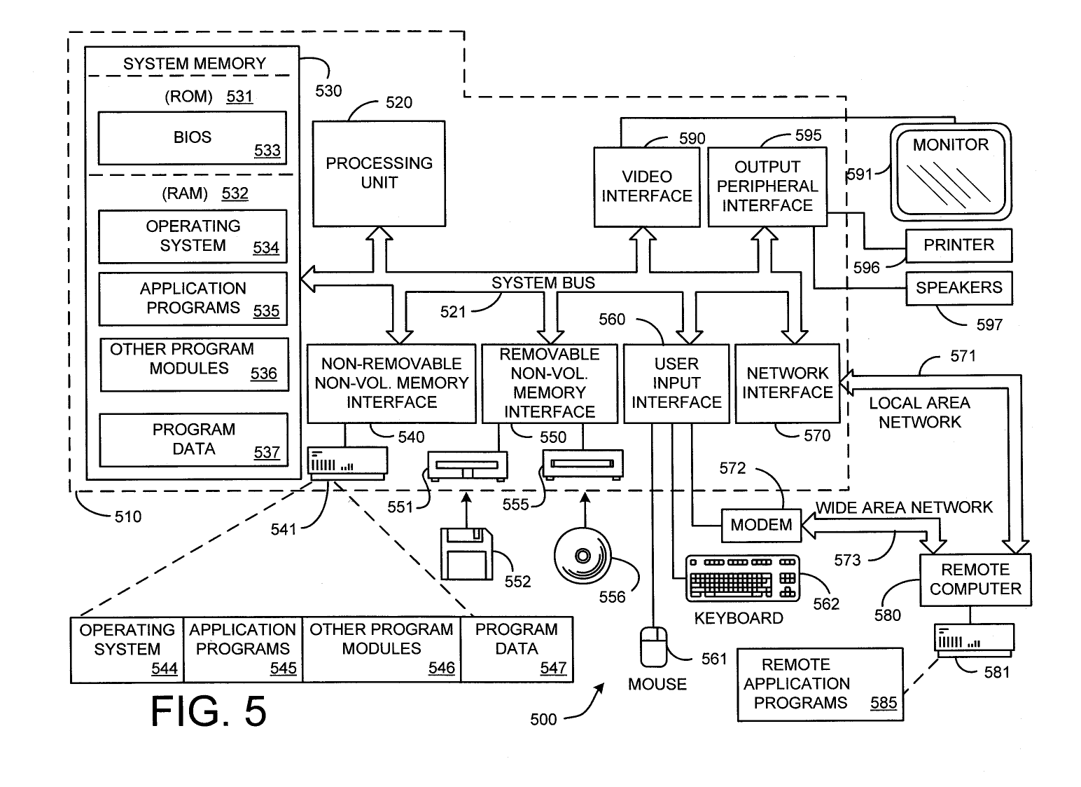

FIG. 5 illustrates an example of a suitable computing system environment in which the remote pointing device and keyboard system and method shown in FIGS. 1-4 may be implemented. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment.

The remote pointing device and keyboard system and method is operational with numerous other general purpose or special purpose computing system environments or configurations. Examples of well known computing systems, environments, and/or configurations that may be suitable for use with the remote pointing device and keyboard system and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The remote pointing device and keyboard system and method may be described in the general context of computer-executable instructions, such as program modules, being executed by a computer. Generally, program modules include routines, programs, objects, components, data structures, etc., that perform particular tasks or implement particular abstract data types. The remote pointing device and keyboard system and method may also be practiced in distributed computing environments where tasks are performed by remote processing devices that are linked through a communications network. In a distributed computing environment, program modules may be located in both local and remote computer storage media including memory storage devices. With reference to FIG. 5, an exemplary system for the remote pointing device and keyboard system and method includes a general-purpose computing device in the form of a computer 510 (the personal computing device 110 and the handheld computing device 105 are examples of the computer 510).

Components of the computer 510 may include, but are not limited to, a processing unit 520 (such as a central processing unit, CPU), a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer readable media. Computer readable media can be any available media that can be accessed by the computer 510 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 510. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 540 includes computer storage media in the form of volatile and/or nonvolatile memory such as read only memory (ROM) 531 and random access memory (RAM) 532. A basic input/output system 533 (BIOS), containing the basic routines that help to transfer information between elements within the computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information (or data) into the computer 510 through input devices such as a keyboard 562, pointing device 561, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 520 through a user input interface 560 that is coupled to the system bus 521, but may be connected by other interface and bus structures, such as, for example, a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through an output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for remotely simulating behavior of a pointing device and keyboard on a personal computer from a handheld computing device, comprising:
using a touch panel and a keypad on the handheld computing device to input commands and data intended for the personal computer;
processing the commands and data on the handheld computing device to prepare for transmission;
transmitting the commands and data over a Bluetooth connection between the personal computing device and the handheld computing device;
receiving the commands and data at the personal computing device;
translating the commands and data into a corresponding desired pointing device and keyboard behavior;
sending the desired pointing device and keyboard behavior to an operating system of the personal computing device; and
executing the pointing device and keyboard behavior using the operating system.

2. The method of claim 1, further comprising:
installing a first application on the personal computing device; and
installing a second application on the handheld computing device.

3. The method of claim 2, further comprising:
opening the first application; and
searching all available Bluetooth devices for a port opened by the handheld computing device.

4. The method of claim 3, further comprising:
establishing a connection between the personal computing device and the handheld computing device; and
having the first application wait for a transmission from the handheld computing device.

5. The method of claim 4, further comprising having the first application retrieve the transmission from the handheld computing device.

6. The method of claim 5, further comprising:
performing any necessary computation on the transmission; and
translating the transmission using a pre-defined protocol such that the commands and data are converted into a corresponding desired pointing device and keyboard behavior

7. The method of claim 6, wherein the pre-defined protocol further comprises correlating a touch panel action on the handheld computing device with a pointing device action on the personal computing device.

8. The method of claim 7, wherein the pre-defined protocol further comprises correlating a keypad action on the handheld computing device with a keyboard action on the personal computing device.

9. The method of claim 8, wherein the keypad is displayed on and accessed through the touch panel of the handheld computing device.

10. The method of claim 2, further comprising having the second application open a port and wait for acknowledgement from the first application.

11. The method of claim 10, further comprising using the second application to transmit commands including touch panel coordinates and data including clicking events and keys pressed.

12. The method of claim 1, wherein the handheld computing device is a Pocket Personal Computer (PPC).

13. The method of claim 1, wherein the handheld computing device is a smartphone.

14. A computer-readable medium having computer-executable instructions for controlling a personal computer running a presentation application by using a handheld computer, comprising:
activating a first application on the personal computer and a second application on the handheld computer;
entering commands using a touch panel of the handheld computer and data using a keypad of the handheld computer;
using the second application to process the commands and data for transmission to the personal computer;
transmitting the commands and data from the handheld computer to the personal computer over a Bluetooth connection;
using the first application to retrieve and translate the commands and data according to a pre-defined protocol; and
using the operating system of the personal computer to execute the commands and data such that a user can control the presentation application running on the personal computer from the handheld computer.

15. The computer-readable medium of claim 14, further comprising translating movement from the touch panel of the handheld computer to movement of a pointing device on the personal computer.

16. The computer-readable medium of claim 14, further comprising translating input from the keypad of the handheld computer to input from a keyboard of the personal computer.

17. A computer-implemented process for remotely controlling a keyboard and a pointing device of a personal computer using a touch panel of a handheld device, comprising:
entering a command on a touch panel of the handheld device;
entering data on a keypad of the handheld device;
transmitting the command and data to the personal computer over a Bluetooth connection;
converting the command into pointing device behavior recognizable by an operating system on the personal computer; and
converting the data into keyboard behavior recognizable by the operating system on the personal computer.

18. The computer-implemented process of claim 17, wherein converting the command into pointing device behavior recognizable by an operating system on the personal computer further comprises converting touch panel x-y coordinates to display device x-y coordinates, where the display device is connected to the personal computer.

19. The computer-implemented process of claim 18, wherein the data that is converted into keyboard behavior recognizable by the operating system on the personal computer further comprises clicking event information and key pressed information.

20. The computer-implemented process of claim 18, wherein a double click on the touch panel on the handheld device correlates to a double click by the pointing device on the personal computer.
